(19) United States
(12) Patent Application Publication
(10) Pub. No.: US 2011/0199235 A1
(43) Pub. Date: Aug. 18, 2011

(54) CONTROLLABLE SIGN FOR USE WITH ALTERNATE SIDE STREET PARKING

(75) Inventor: Thomas John, New Hyde Park, NY (US)

(73) Assignee: American Gardens Management Co., New Hyde Park, NY (US)

(21) Appl. No.: 12/888,649

(22) Filed: Sep. 23, 2010

Related U.S. Application Data
(60) Provisional application No. 61/245,397, filed on Sep. 24, 2009.
(60) Provisional application No. 61/347,531, filed on May 24, 2010.

(51) Int. Cl. B60Q 1/48

(52) U.S. Cl. 340/932.2

(57) ABSTRACT

A method for dynamically changing information conveyed by a street sign to alert drivers that parking is permitted as a result of an official vehicle approaching and/or passing the sign and transmitting a control signal to cause updating of the sign.

### CROSS-REFERENCE TO RELATED APPLICATION

The present application claims the benefit of U.S. patent application Ser. No. 61/245,397, filed Sep. 24, 2009 and U.S. patent application Ser. No. 61/347,531, filed May 24, 2010, which are hereby incorporated by reference in their entireties.

### TECHNICAL FIELD

The present invention relates to traffic signs and in particular, the present invention relates to a system and method for dynamically changing information conveyed by the traffic sign to alert drivers that parking is permitted as a result of an official vehicle approaching and/or passing the sign and transmitting a control signal to cause updating of the sign.

### BACKGROUND

There are thousands of vehicles that are parked on streets illegally due to unavailability of parking spots. In addition, there are a number of rules that regulate parking on the streets. For example, “alternate side parking” refers to regulation of street parking where parking is permitted on one side of the street on certain days, while parking is permitted on the other side of the street on other days. Alternate side parking is often in place in order to allow cleaning of the streets since this cleaning requires that the curb be free of cars to permit proper cleaning thereof.

Typically, when a parking street is closed for cleaning there is a permanent sign on the street indicating the time and day when vehicles can not park on a particular side of the street. For example, a sign may indicate that on Tuesday and Fridays, parking is not permitted from 9 AM to 11 Am for street cleaning. A street sweeping vehicle comes on these scheduled times and days for cleaning the streets by traveling alongside the curb with the vehicle's cleaning mechanism in operation.

In the permanent parking signs, a large block of time is indicated where parking is prohibited to allow for delayed arrival of the street sweeper or to permit rerouting of the street sweeper since depending upon the route of the street sweeper, the street sweeper may arrive at the beginning of the block of time or near the end of the block of time. In addition, certain events can cause the cancellation of the street cleaning and therefore, the alternate side parking rules are suspended. For example, the parking rules can be suspended on Holidays and due to bad weather or other reasons. It is frustrating for drivers who have to move their vehicle and then wait for the whole time block to expire even though the street sweeper has passed through and already cleaned the street. This leads to illegal parking of vehicles and addition work for law enforcement authorities.

There is thus a need for a better parking system and signs that dynamically provide a real-time indication whether vehicles can park on a particular street as a result of a street sweeper having already passed through and cleaned the street.

### SUMMARY

The present invention relates to a system and method for dynamically changing information conveyed by the sign and to alert drivers that parking is permitted as a result of an official vehicle approaching and/or passing the sign and transmitting a control signal to cause updating of the sign.

### BRIEF DESCRIPTION OF THE DRAWINGS

FIG. 1 is a front view of a conventional No Parking sign;

FIG. 2 is a schematic view of a vehicle that incorporates a transmitting device to communicate with a display system (sign) of the present invention;

FIG. 3 is a schematic showing the transmitting device on the vehicle in accordance with the present invention; and

FIG. 4 is a schematic showing the various components in the display system (sign) of the present invention.

### DETAILED DESCRIPTION OF CERTAIN EMBODIMENTS OF THE INVENTION

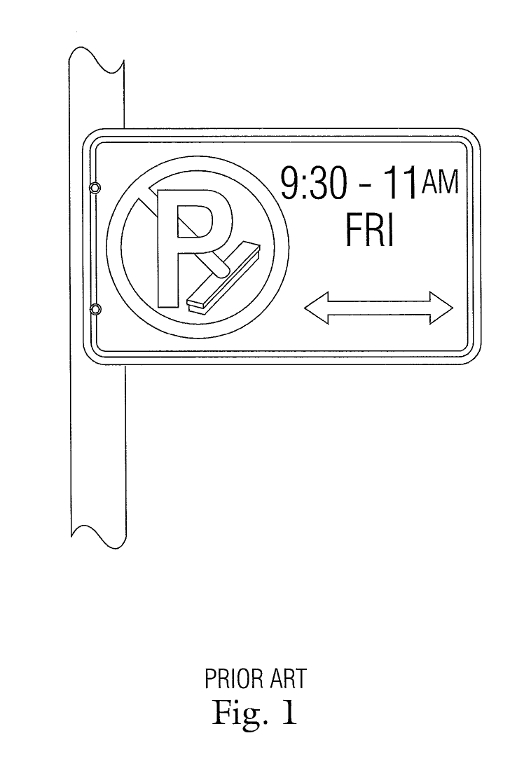

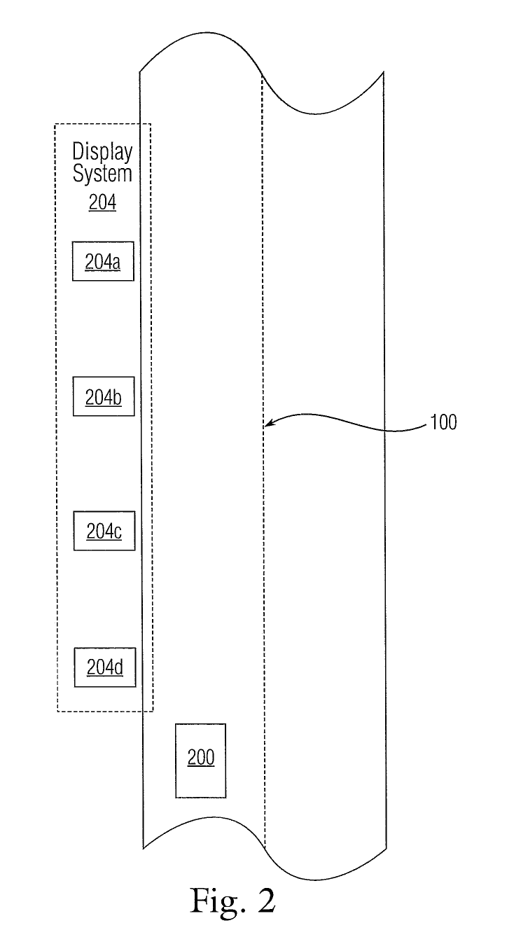

In accordance with one embodiment of the present invention, a system 100 for dynamically changing in real-time the information that is conveyed on a traffic sign, especially a sign that is associated with alternate side parking regulation, is provided and illustrated in FIGS. 1-4. The system 100 includes an official vehicle 200, such as a department of transportation vehicle or a sanitation vehicle. FIG. 2 illustrates one exemplary form of vehicle 200 in the form of a street sweeping vehicle; however, it will be appreciated that the vehicle 200 can assume any number of other forms, including but not limited to a maintenance vehicle, a motor vehicle, etc.

As is known, the street sweeping vehicle 200 has a particular route each day that it follows to clean a particular side of the street. Signs are placed along the route to indicate the specific time period in a given day that the street sweeping vehicle 200 is to clean this particular street. The no parking time period that is indicated on the sign is typically from 1.5-3 hours (e.g. 10 am-1 pm), hence vehicles can not park on the street for the entire time period. This is true even if the cleaning has already been performed by the street sweeper prior to the end of the stated time period on the side. As a result, other vehicles can not park their vehicles even when the streets have been cleaned and are ready to be occupied. For example, FIG. 1 shows a sign displaying no parking from 9:30-11:00 am on Friday due to street sweeping. This means even if the sweeping is performed at 9:45 am, people still can not park vehicles until after 11:00 am.

In accordance with the present invention, as the vehicle 200 passes the display system (sign) 204, the vehicle 200 communicates with the display system 204 to send a signal to indicate that cleaning of the parking streets has been completed. The vehicle 200 can also send other possible updates or other information that can be displayed on the sign 204. There can be more than one display system (sign) 204 installed along the length of the street. FIG. 2 shows signs 204a, 204b, 204c, 204d, etc. that are located along the length of the street.

As described in detail herein, the vehicle 200 and the display system 204 has particular utility for use where a street is scheduled for cleaning or maintenance but either the cleaning is canceled due to bad weather or the cleaning has already been performed before the end of the parking ban time period. In the present system 100, the vehicle 200 communicates with the display system 204 to display whether the cleaning work has been completed and thus, whether vehicles are permitted to begin parking along the street.

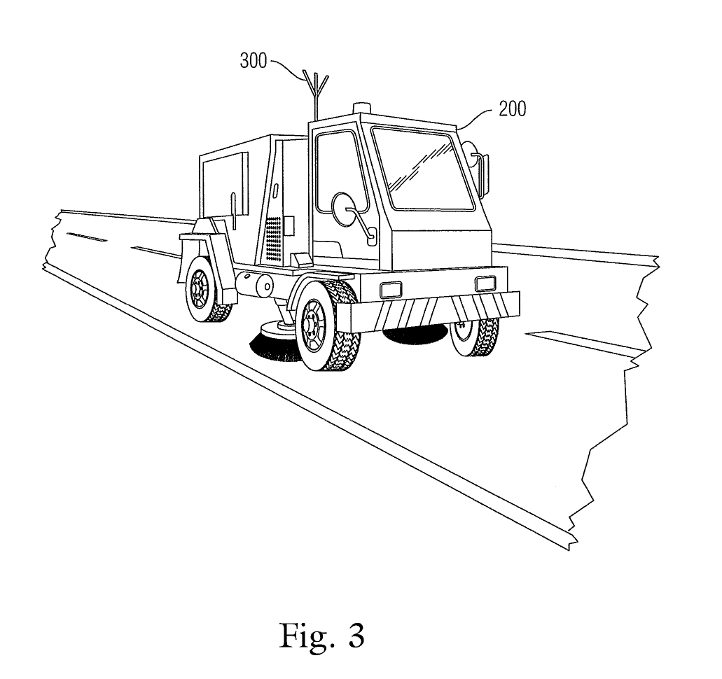

The vehicle 200 is shown in more detail in FIG. 3. The vehicle includes a communication device such as a transmitting device 300 to communicate with the display system 204. The transmitting device 300 contains information that uniquely identifies each display system 204, time and day of next scheduled cleaning and changes the display of an indicator device.

The transmitting device 300 can take any number of different forms including but not limited to a wireless device, a Bluetooth device, an Infrared device, or any other wirelessly communicating device that is capable of communicating (e.g., sending control signals) with the display system 204. The transmitting device 300 can simply transmit a control signal to the display system 204 (sign) to instruct and change the status of an indicator that is part of the sign (display system). The transmitting device 300 can transmit information to the display system 204 such as time, date, a sign identifier, along with information to change a light or an alert message on an indicator device that is part of the sign (display system 204). This information helps other vehicles to determine whether the street has been cleaned and is thus ready to be reoccupied. In accordance with one embodiment of the present invention, the information to the display system 204 can be transmitted from a central location.

In a particular embodiment of the invention, as the vehicle 200 is cleaning the street and approaches, crosses or is near the display system (sign) 204d, the vehicle dynamically transmits a control signal or information from the transmitting device 300 to the display system 204d to indicate that cleaning has been performed and that cars can be parked along the street. The transmitting device 300 can also send other information including the next scheduled time and day, and changes a display on the indicator device. As the street sweeping vehicle cleans the street, the transmitting device 300 dynamically transmits information (control signal) updating the display system say, 204a, 204b, 204c, 204c, etc.

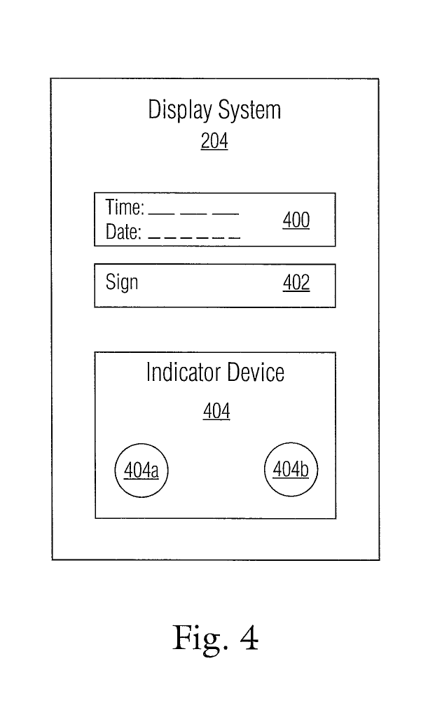

The display system 204 in FIG. 4 can take any number of different forms including but not limited to an RFID tag or a chip, or a bar code member, or any other structure that is capable of storing identification information and processing the information to display on a display screen. The display system can share the information received from the vehicle 200 wirelessly with other vehicles.

In the embodiment where the transmitting device 300 sends more than an indicator control signal, the display system 204 stores information received from the transmitting device 300, processes the information and displays the information on the display screen. This can include the next scheduled no parking time and day 400, and a sign display or logo 402. The sign also includes an indicator device 404. The display system can include a “No Parking” sign in space 402 along with an indicating time and day in space 400, and the indicator device 404.

The sign 402 can take any number of different forms including but not limited to No Parking, No Parking for Maintenance, No Parking Loading Zone, No Parking Tow Away Zone, Alternate Side Parking Regulation, etc.

The indicator device 404 includes a display screen that can include a light 404a, 404b to alert other vehicles indicating availability of parking. There can be more than one display light 404a and 404b on the indicator device such as shown in FIG. 4. One of the display lights on the indicator device can be a RED light to alert that parking is not available and a GREEN light indicating that the parking is available. There can be other combination of lights, sequence of lights or message to alert other vehicles regarding the availability of parking. For example, during the no parking time period and prior to arrival of the street sweeping vehicle 200, a light that is part of the indicator device 404 can be illuminated red to indicate to drivers that parking is prohibited. Conversely, when the vehicle 200 approaches a sign (display system 204), it communicates with the sign (e.g., sending a control signal) that alerts the sign that the street sweeping has been performed and therefore, the display system 204 can be updated to indicate that parking is now permitted on the street as by illuminating a green light. The sign can include clear legends so that drivers clearly understand the illuminated lights. For example, the green light can include a complementary legend that says something along the lines “OK to park” or “Parking Permitted”.

The transmitter is of sufficient strength that in the case of where a vehicle is illegally parked in the way of the street sweeper, the street sweeper has to move into another lane to pass by the illegally parked vehicle, the signal from the transmitter is received by the receiver or the like that is part of the sign.

It will therefore be appreciated that the present invention is in the form of a system that dynamically updates information on street signs to alert vehicles in real-time that parking along the street is permitted. The actuator of the system is in the form of a mobile vehicle that transmits a control signal(s) to the sign. The transmitter can be configured to continuously send a control signal to the sign 204 to change the status of the indicator 404 and therefore, as the vehicle 200 passes by a series of signs, the status/indicator of each sign 204 successively changes. It will also be appreciated that the sign 204 can include a controller or the like that executes software and therefore, once the next time period of no parking is reached, the controller of the sign automatically instructs the indicator to change to a no parking status (e.g., red light), thereby indicating that the banned parking period is no longer in effect. Once the vehicle 200 approaches/passes, the transmitted control signal causes the indicator to change its status as described above.

While the invention has been described in connection with certain embodiments thereof, the invention is capable of being practiced in other forms and using other materials and structures. Accordingly, the invention is defined by the recitations in the claims appended hereto and equivalents thereof.

In yet another embodiment, the display system is part of an existing structure that is located along the street. For example, the display system can be incorporated or attached into a street lamp pole. As mentioned herein, the display system can be a modular device that can be attached to another structure, such as a lamp pole. The indicator 404 can thus be part of the display system that is attached to a lamp pole. In other words, for a single street, a structure near the beginning of the street block can be part of the display system of the present invention for indicating whether it is ok to park on this side of the street due to the vehicle 200 having already passed by the display system (module).

In this embodiment, there can be a single display system with indicator 404 on one street block such that when a vehicle looking for parking enters this street block, the driver can simply look at the indicator 404 coupled to the street lamp to determine whether it is proper to park or not. Instead of having a plurality of street signs per one street block, a single indicator 404 can be present on an existing structure (street lamp) at or near the beginning of the street. When a driver or pedestrian views the indicator, he or she will be able to immediately determine whether parking is permitted at this time. It will be understood that in all of the present embodiments, a controller within the module can be programmed so that the indicator will turn to red or some other color or display some message that indicates that parking is not permitted at this time. For example, if the normal no parking due to street sweeping is from 9 am-12 pm on Tuesday and Thursday, the

The present invention is also not limited to just conventional alternate side of the street parking rules but rather can be easily customizable for other events, such as parades, etc. For example, if no parking is permitted on the street, a message can be set to the display units to change the indicator 404 to red or give some other message that parking is not permitted at this time. When it is appropriate to start parking again, another message can be sent to the display units to change back to normal operating protocol. Because each display system can be part of a network, they can be easily customized and the status and operation of each can be readily changed.

The operation of the display system and indicator 404 can be the same or similar to the operation previously described herein with respect to other embodiments.

It will also be appreciated that the display system can be powered by an alternative energy source and in particular, the display system can be powered by solar energy. Thus, the display system (indicator) can be a module that includes a solar panel operatively connected thereto to power the electronics thereof, such as the receiver and transmitter, etc. For example, when the module is attached to a lamp pole, the solar panel can be angled relative to the lamp pole in a direction that will face the sun for the greatest amount of time during the day.

While it is envisioned that the display unit (with indicator) be capable of being added to an existing structure, such as a lamp pole, it will be appreciated that the display unit can be provided as its own stand-a-lone structure, such as a pole, that is disposed at or near the beginning of the street on one side thereof.

In yet another aspect of the present invention, an optional service for alerting subscribers of the status of any of the displays systems on a network can be provided for a fee. For example, a user can enter one or more streets to be added to a personal alert system such that an alert is sent to the user when the indicator has changed status as occurs when the vehicle passes the display unit and the indicator 404 changes its status. The alert is delivered to the user over a network (e.g., Internet) and can assume any number of different forms including an email or text message.

The alert or message is not limited to being a text message or email, but can also be in the form of information provided in an application that is part of a smartphone. For example, a user can access an application on a smartphone and view a map or type in an address and be shown a map with icons that indicate whether a street has been cleaned or not and whether parking is permitted. For example, many applications that are available on smartphones use gps to display information. Thus, when a user accesses the application, the default can be that the map shows the present location, based on gps information, and all streets in the immediate vicinity can be shown and an indicator, such as a colored circle, for each street can be shown or the street itself can be color coded based on whether parking is permitted. For example, streets that can be parked on can be indicated with a green color and those which cannot be parked on can be indicated with a red color. This allows the user to easily determine whether parking is permitted. In terms of alternative side parking rules, each street can have two indicators for each side of the street. For example, for one street, the left side of the street can have one indicator, while the right side of the street can have another indicator. This can be in the form of a colored circle on one side of the street, or the street itself can have two lines one for each side of the street with each line being independently colorable.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions can be loaded onto one or more general-purpose computers, special purpose computers, or other programmable data processing translator to produce machines, such that the instructions, which execute on the computers or other programmable data processing translator create means for implementing the functions specified in the block or blocks. Such computer program instructions can also be stored in a computer-readable memory that can direct a computer or other programmable data processing apparatus to function in a particular manner, such that the instructions stored in the computer-readable memory produce an article of manufacture including instruction means that implement the function specified in the block or blocks. Furthermore, such computer program instructions can be made available for download and/or downloaded over a communication network.

What is claimed is:

1. A method for dynamically changing information conveyed by a street sign to alert drivers that parking is permitted on a side of the street comprising the steps of:
sending a control signal from a vehicle that is, in close proximity to the street sign that causes a controller associated with the street sign to update the street sign to indicate that parking is now permitted on the street.

2. The method of claim 1, wherein the vehicle is a street sweeper vehicle that cleans the street and passes the street sign during cleaning the street.

3. The method of claim 1, wherein the street sign is an alternate side parking regulation sign.

4. The method of claim 1, wherein the vehicle includes a transmitter that sends the control signal that indicates a presence of the vehicle in a proximate relation to the street sign, the street sign having a receiver that receives the control signal.

5. The method of claim 4, wherein the control signal is sent wirelessly.

6. The method of claim 1, wherein the street sign includes a dynamic display and an indicator for indicating whether parking is permitted on the side of the street.

7. The method of claim 6, wherein the indicator includes a light that color of which conveys information to a driver as to whether parking is permitted.

8. The method of claim 1, further including the step of:
transmitting a message wirelessly to a subscriber to alert the subscriber that parking on a particular street is permitted due to the vehicle having passed the street sign and caused the sign to be updated.

9. The method of claim 8, wherein the subscriber inputs particular streets that are of interest and messages are only sent to the subscriber pertaining to those inputted streets.

10. The method of claim 8, wherein the message includes a color coded map where streets that parking is permitted are indicated in a first color and streets where parking is still prohibited are indicated in a second color.

11. A system for dynamically changing information conveyed by a street sign to alert drivers that parking is permitted on a side of the street comprising:
a vehicle that includes a transmitter for transmitting a control signal; and
a sign having a dynamic display, the sign having a receiver that receives the control signal and upon receipt of the control signal, a controller causes the display to be updated to indicate that street parking is permitted.

12. The system of claim 11, wherein the vehicle is a street sweeper vehicle that cleans the street and passes the street sign during cleaning the street.

13. The system of claim 11, wherein the street sign is an alternate side parking regulation sign.

14. The system of claim 11, wherein the control signal indicates a presence of the vehicle in a proximate relation to the street sign, the street sign having a receiver that receives the control signal.

15. The system of claim 14, wherein the control signal is sent wirelessly.

16. The system of claim 11, wherein the display includes an indicator that includes a light that color of which conveys information to a driver as to whether parking is permitted.
